(19) United States
(12) Patent Application Publication
(10) Pub. No.: US 2007/0146426 A1
(43) Pub. Date: Jun. 28, 2007

(54) ALL-INKJET PRINTED THIN FILM TRANSISTOR

(76) Inventors: Brian K. Nelson, Shoreview, MN (US); Dennis E. Vogel, Lake Elmo, MN (US); Mark E. Napierala, Saint Paul, MN (US); Tzu-Chen Lee, Woodbury, MN (US)

Correspondence Address: 3M INNOVATIVE PROPERTIES COMPANY, PO BOX 33427, ST. PAUL, MN, 55133-3427, US

(21) Appl. No.: 11/275,366

(22) Filed: Dec. 28, 2005

(51) Int. Cl. B41J 2/135

(52) U.S. Cl. 347/44

(57) ABSTRACT

A method is provided for making a thin film transistor comprising the steps of: providing a substrate; applying a gate electrode ink by inkjet printing; applying a dielectric ink over by inkjet printing; applying a semiconductor ink by inkjet printing; and applying a source and drain electrode ink by inkjet printing. In some embodiments the semiconductor ink comprises a solvent and a semiconducting material comprising: 1-99.9% by weight of a polymer; and 0.1-99% by weight of a functionalized pentacene compound as described herein.

### FIELD OF THE INVENTION

This invention relates to the manufacture of thin film transistors by inkjet printing.

### BACKGROUND OF THE INVENTION

U.S. Pat. No. 6,690,029 B1 purportedly discloses certain substituted pentacenes and electronic devices made therewith.

WO 2005/055248 A2 purportedly discloses certain substituted pentacenes and polymers in top gate thin film transistors.

### SUMMARY OF THE INVENTION

Briefly, the present invention provides a method of making a thin film transistor comprising the steps of: providing a substrate; applying a gate electrode ink by inkjet printing; applying a dielectric ink over by inkjet printing; applying a semiconductor ink by inkjet printing; and applying a source and drain electrode ink by inkjet printing. In some embodiments the gate electrode ink is applied directly to the substrate. In some embodiments the dielectric ink is applied over at least a portion of the gate electrode ink. In some embodiments the semiconductor ink is applied over at least a portion of the dielectric ink and the source and drain electrode ink is applied over at least a portion of the semiconductor ink. In some embodiments the source and drain electrode ink is applied over at least a portion of the dielectric ink and the semiconductor ink is applied over at least a portion of the source and drain electrode ink. In some embodiments the semiconductor ink is applied directly to the substrate, the source and drain electrode ink is applied over at least a portion of the semiconductor ink, the dielectric ink is applied over at least a portion of the source and drain electrode ink, and the gate electrode ink is applied over at least a portion of the dielectric ink. In some embodiments the source and drain electrode ink is applied directly to the substrate, the semiconductor ink is applied over at least a portion of the source and drain electrode ink, the dielectric ink is applied over at least a portion of the semiconductor ink, and the gate electrode ink is applied over at least a portion of the dielectric ink. In some embodiments the semiconductor ink comprises a solvent and a semiconducting material comprising:

1-99.9% by weight of a polymer; and

0.1-99% by weight of a compound according to Formula I: 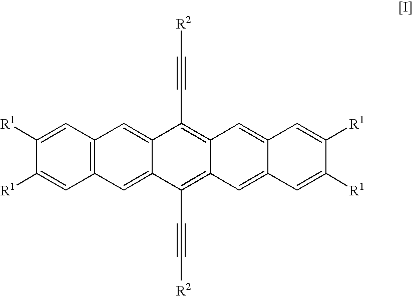
where each R¹ is independently selected from H and CH₃ and each R² is independently selected from branched or unbranched C2-C18 alkanes, branched or unbranched C1-C18 alkyl alcohols, branched or unbranched C2-C18 alkenes, C4-C8 aryls or heteroaryls, C5-C32 alkylaryl or alkyl-heteroaryl, a ferrocenyl, or SiR³₃ where each R³ is independently selected from hydrogen, branched or unbranched C1-C10 alkanes, branched or unbranched C1-C10 alkyl alcohols or branched or unbranched C2-C10 alkenes. In some embodiments the polymer has a dielectric constant at 1 kHz of greater than 3.3, and typically is selected from the group consisting of: poly(4-cyanomethyl styrene) and poly(4-vinylphenol).

### BRIEF DESCRIPTION OF THE DRAWING

FIG. 1 is a schematic depiction of the layers present in a top contact/bottom gate thin film transistor.

FIG. 2 is a schematic depiction of the layers present in a bottom contact/bottom gate thin film transistor.

FIG. 3 is a schematic depiction of the layers present in a top contact/top gate thin film transistor.

FIG. 4 is a schematic depiction of the layers present in a bottom contact/top gate thin film transistor.

FIG. 5 is a schematic depiction of the bottom contact/bottom gate thin film transistor of Example 1.

FIG. 6 is a micrograph of a bottom contact/bottom gate thin film transistor of Example 1 with a 2.0 mm scale bar.

FIG. 7 is a graph of performance values for the bottom contact/bottom gate thin film transistor of Example 1.

### DETAILED DESCRIPTION

Thin film transistors show promise in the development of lightweight, inexpensive and readily reproduced electronic devices. The present invention provides for all-ink-jet, all-additive manufacture of thin film transistors.

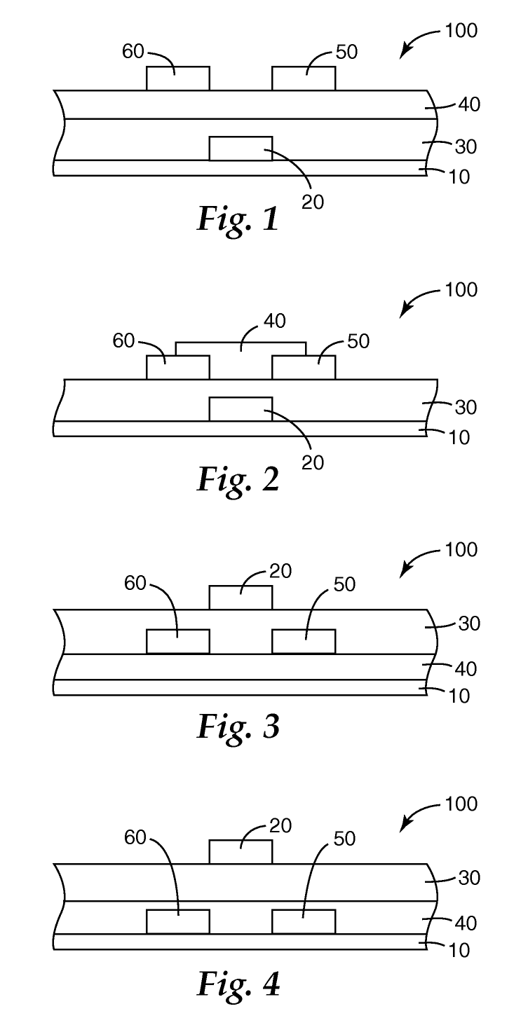

Thin films transistors are known in four principle geometries. With reference to each of FIG. 1, representing a top contact/bottom gate thin film transistor, FIG. 2, representing a bottom contact/bottom gate thin film transistor, FIG. 3, representing a top contact/top gate thin film transistor, and FIG. 4, representing a bottom contact/top gate thin film transistor, thin film transistor 100 includes substrate 10, gate electrode 20, dielectric layer 30, semiconductor layer 40, source electrode 50, and drain electrode 60. Typically, each of the source electrode 50 and drain electrode 60 will overlap the gate electrode 20 to a slight extent.

In the top gate designs depicted in FIGS. 3 and 4, the gate electrode 20 is above the dielectric layer 30 and both the gate electrode 20 and the dielectric layer 30 are above the semiconductor layer 40. In the bottom gate designs depicted in FIGS. 1 and 2, the gate electrode 20 is below dielectric layer 30 and both the gate electrode 20 and the dielectric layer 30 are below the semiconductor layer 40. As a result, the manufacture of the bottom gate designs by inkjet printing techniques requires a semiconductor that can be applied in solvent to previously coated dielectric layers without disruption or dissolution of those layers.

Inkjet printing is well known in the art, e.g., for printing graphics, including multi-color graphics. Inkjet printing enables precise positioning of very small drops of ink. Any suitable inkjet printing system may be used in the practice of the present invention, including thermal, piezoelectric, and continuous inkjet systems. Most typically a piezoelectric inkjet system is used. Inks useful in inkjet printing are typically free of particulates greater than 500 nm in size and more typically free of particulates greater than 200 nm in size. Inks useful in inkjet printing typically require suitable rheological properties.

Inkjet printing of thin film transistors requires the use of inks which may be applied without damage to previously applied inks. The inks and materials of the present invention enable the construction of a thin film transistor wherein every layer is made by inkjet printing. As a result, a relatively inexpensive yet precise technology can be used to generate electronic circuits. Furthermore, in some embodiments of the present invention, transistor manufacture requires only additive steps. That is, etching or other material removal steps may be eliminated.

Semiconductor inks useful in the present invention typically include a solvent and a semiconducting material, which typically includes a polymer and a semiconducting compound. Any suitable solvent may be used, which may include ketones, aromatic hydrocarbons, and the like. Typically the solvent is organic. Typically the solvent is aprotic.

Semiconductor inks useful in the present invention may include any suitable polymer. Typically, the polymer has a dielectric constant at 1 kHz of greater than 3.3, more typically greater than 3.5, and more typically greater than 4.0. The polymer typically has a M.W. of at least 1,000 and more typically at least 5,000. Typical polymers include poly(4-cyanomethyl styrene) and poly(4-vinylphenol). Cyanopullulans may also be used.

Typical polymers also include those described in U.S. Patent Publication No. 2004/0222412 A1, incorporated herein by reference. Polymers described therein include substantially nonfluorinated organic polymers having repeat units of the formulas: 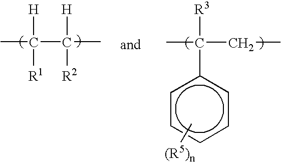
wherein:

each R¹ is independently H, Cl, Br, I, an aryl group, or an organic group that includes a crosslinkable group;

each R² is independently H, an aryl group, or R⁴;

each R³ is independently H or methyl;

each R⁵ is independently an alkyl group, a halogen, or R⁴;

each R⁴ is independently an organic group comprising at least one CN group and having a molecular weight of about 30 to about 200 per CN group; and

n=0-3;

with the proviso that at least one repeat unit in the polymer includes an R⁴.

The semiconductor material in the ink contains the polymer in an amount of 1-99.9% by weight, more typically 1-10% by weight.

Semiconductor inks useful in the present invention may include any suitable semiconducting compound. The semiconducting compound may be a functionalized pentacene compound according to Formula I: 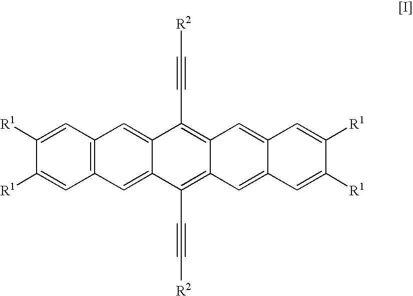
where each R¹ is independently selected from H and CH₃ and each R² is independently selected from branched or unbranched C2-C18 alkanes, branched or unbranched C1-C18 alkyl alcohols, branched or unbranched C2-C18 alkenes, C4-C8 aryls or heteroaryls, C5-C32 alkylaryl or alkyl-heteroaryl, a ferrocenyl, or SiR³₃ where each R³ is independently selected from hydrogen, branched or unbranched C1-C10 alkanes, branched or unbranched C1-C10 alkyl alcohols or branched or unbranched C2-C10 alkenes. Typically each R¹ is H. Typically, each R² is SiR³₃. More typically each R² is SiR³₃ and each R³ is independently selected from branched or unbranched C1-C10 alkanes. Most typically, the compound is 6,13-bis(triisopropylsilylethynyl)pentacene (TIPS-pentacene), shown in formula II:

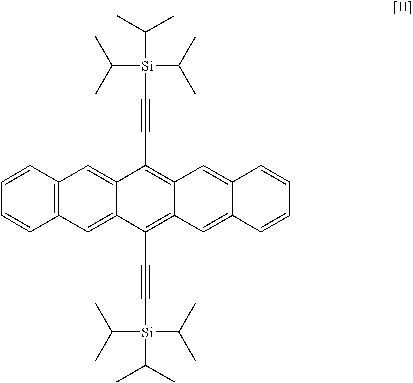

The semiconductor material contains the compound of Formula I or of Formula II in an amount of 0.1-99% by weight.

Any suitable dielectric ink may be used, including composistions disclosed in U.S. patent application Ser. No. 11/282,923, incorporated herein by reference.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all reagents were obtained or are available from Aldrich Chemical Co., Milwaukee, Wis., or may be synthesized by known methods.

Materials were obtained from the following sources without further purification:

Polyethylene napthalate (PEN), Dupont Teijin films, Q65A PEN.

Cabot silver ink, Inkjet Silver Conductor, bulk resistivity 4-32 mW cm, from Cabot Printable Electronics and Displays, Albuqerque, N. Mex.

Perfluorothiophenol, Aldrich Chemical Company.

Toluene, EMD Chemicals, Inc. Gibbstown, N.J.

Cyclohexanone, EMD Chemicals, Inc. Gibbstown, N.J.

6,13-Di(triisopropylsilylethylnyl)pentacene (TIPS-pentacene) was synthesized as disclosed in U.S. Pat. No. 6,690,029 B1 at Example 1.

Poly(4-vinylphenol) MW 9,000 to 11,000 Sp.gr. 1.16 (PVP), Polyscience, Inc. Warrington, Pa.

Pentaerythritol tetraacrylate (SR444), Sartomer, West Chester, Pa.

Irgacure 819, Ciba specialty Chemicals, Basel Switzerland.

### Preparatory Example—Preparation of Polymer A

Polymer A is a nitrile-containing styrene-maleic anhydride copolymer that is described in U.S. Patent Publication No. 2004/0222412 A1, incorporated herein by reference. The synthesis is described therein at paragraphs 107 and 108 under the caption “Example 1, Synthesis of Polymer 1,” as follows:

A 250-milliliter (mL), three-necked flask fitted with magnetic stirrer and nitrogen inlet was charged with 8.32 grams (g) 3-methyl aminopropionitrile (Aldrich) and a solution of 20.00 g styrene-maleic anhydride copolymer (SMA 1000 resin available from Sartomer, Exton, Pa.) in 50 mL of anhydrous dimethylacrylamide (DMAc, Aldrich). After the mixture was stirred for 30 minutes (min) at room temperature, N,N-dimethylaminopyridine (DMAP) (0.18 g, 99%, Aldrich) was added and the solution was then heated at 110° C. for 17 hours (h). The solution was allowed to cool to room temperature and was slowly poured into 1.5 liters (L) of isopropanol while stirred mechanically. The yellow precipitate that formed was collected by filtration and dried at 80° C. for 48 h at reduced pressure (approximately 30 millimeters (mm) Hg). Yield: 26.0 g.

Twenty grams (20 g) of this material was dissolved in 50 mL anhydrous DMAc followed by the addition of 28.00 g glycidyl methacrylate (GMA) (Sartomer), 0.20 g hydroquinone (J. T. Baker, Phillipsburg, N.J.) and 0.5 g N,N-dimethylbenzylamine (Aldrich). The mixture was flashed with nitrogen and then was heated at 55° C. for 20 h. After the solution was allowed to cool to room temperature, it was poured slowly into 1.5 L of a mixture of hexane and isopropanol (2:1, volume:volume (v/v), GR, E.M. Science) with mechanical stirring. The precipitate that formed was dissolved in 50 mL acetone and precipitated twice, first into the same solvent mixture as used above and then using isopropanol. The solid (Polymer A) was collected by filtration and was dried at 50° C. for 24 h under reduced pressure. (approximately 30 mm Hg). Yield: 22.30 g. FT-IR (film): 3433, 2249, 1723, 1637, 1458, 1290, 1160, and 704 cm⁻¹. Mn (number average molecular weight)=8000 grams per mole (g/mol), Mw (weight average molecular weight)=22,000 g/mol. Tg=105° C. Dielectric constant approximately 4.6.

### Example 1

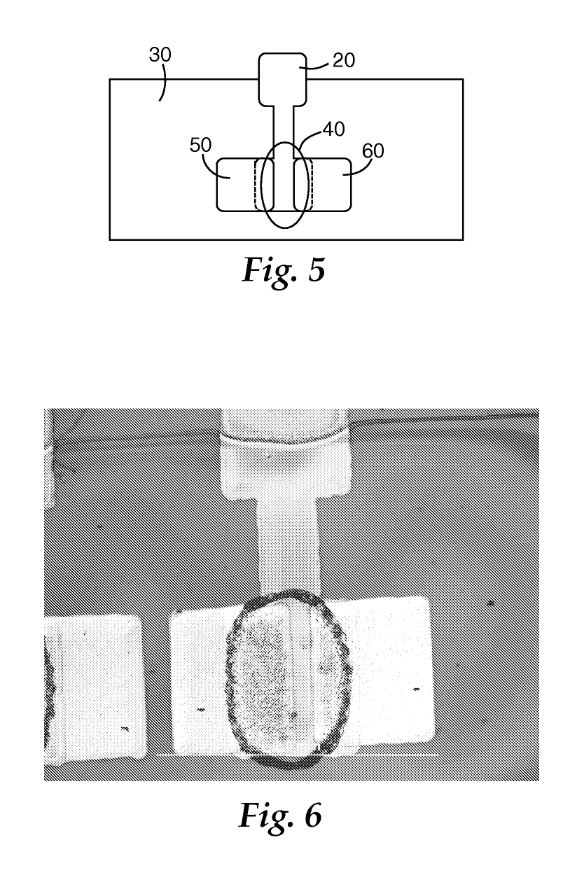

An all inkjet-printed, all-additive array of transistors was printed on a piece of PEN film at 304 dpi using a Spectra inkjet print head SM-128 having a 50 pl drop volume for the silver ink and the dielectric (polymer A) ink and a Spectra inkjet print head SE-128 having a 30 pl drop volume for the semiconductor (TIPS-PVP) ink. Layers were printed in the order: 1. gate, 2. dielectric, 3. source/drain, and 4. semiconductor; according to the pattern depicted in FIG. 5 and the following method.

Gate electrodes (1×1 mm with probe pads 1×1 mm) were printed onto the PEN substrate with Cabot silver ink. This material was cured by heating to 125° C. for 10 minutes. The dielectric layer, a solution of 15 wt % Polymer A, 1.5 wt % Irgacure 819 photoinitiator and 1.5 wt % pentaerythritol tetraacrylate crosslinker (SR444) in isophorone, was printed on top of the gate electrodes so as to cover half of the strip and leave half exposed to make electrical contact. This layer was cured by placing under a bank of short wavelength UV lamps (254 nm) in a nitrogen environment for seven minutes. A pair of source and drain electrodes (1×1 mm) were printed aligned with each gate electrode so as to form a 100 micron channel between the source and drain electrodes over top of the gate electrode while minimizing the amount of overlap with the gate electrode. These electrodes were also printed by inkjet printing using Cabot silver ink followed by a heating step at 125° C. for 10 minutes. This sample was then treated with a 0.1 mmol solution of perfluorothiophenol in toluene for 1 hour. The sample was rinsed with toluene and dried. The semiconductor solution, a solution of 10 wt % PVP and 0.8 wt % TIPS in cyclohexanone, was printed by inkjet in a short line to cover the channel region between the source and drain electrodes but to not touch the semiconductor material form adjacent transistors. The sample was then heated at 120° C. for 10 minutes. FIG. 6 is a micrograph of one of the resulting devices with a 2.0 mm scale bar.

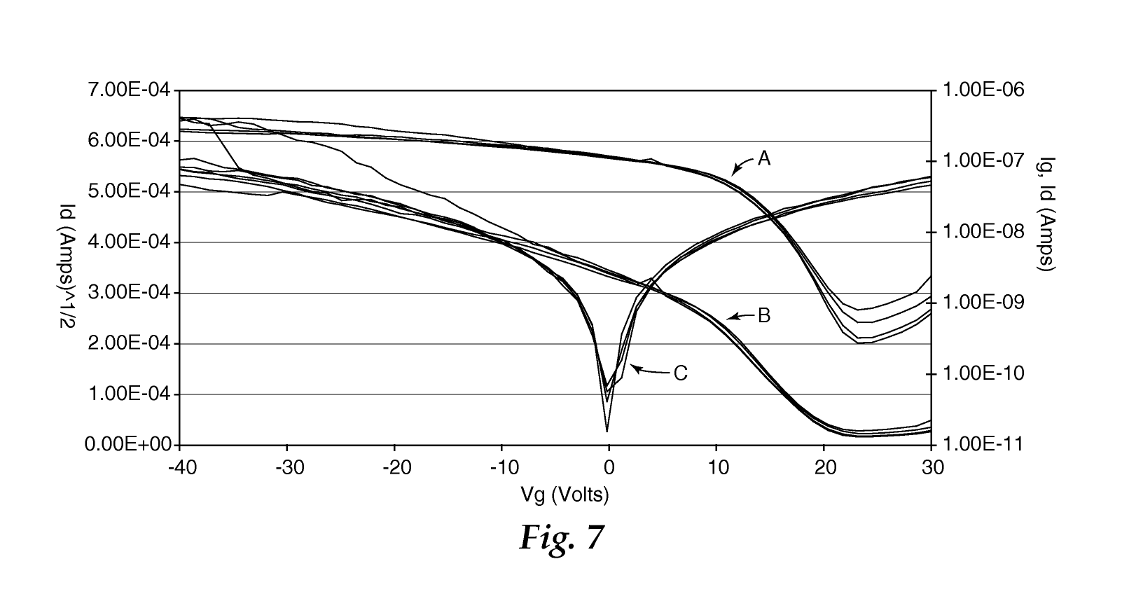

FIG. 7 is a graph of performance values, obtained from the resulting device as follows. Transistor performance was tested at room temperature in air using a Semiconductor Parameter Analyzer (model 4145A from Hewlett-Packard, Palo Alto, Calif.). The square root of the drain-source current (I_{ds}) was plotted as a function of gate-source bias (Vgs), from +10 V to −40 V for a constant drain-source bias (V_{ds}) of −40 V. Using the equation:
I_{ds}=μC×W/L×(V_{gs}−Vₜ)²/2

the saturation field effect mobility was calculated from the linear portion of the curve using the specific capacitance of the gate dielectric (C), the channel width (W) and the channel length (L). The x-axis extrapolation of this straight-line fit was taken as the threshold voltage (Vₜ). In addition, plotting Id as a function of V_{gs} yielded a curve where a straight line fit was drawn along a portion of the curve containing Vₜ. The inverse of the slope of this line was the sub-threshold slope (S). The on/off ratio was taken as the difference between the minimum and maximum drain current (I_{ds}) values of the I_{ds}−V_{gs} curve. In FIG. 7, traces labeled A are measured drain current (I_{ds}), traces labeled B are the square root of measured drain current (I_{ds}), and traces labeled C are measured gate current (I_{gs}).

Various modifications and alterations of this invention will become apparent to those skilled in the art without departing from the scope and principles of this invention, and it should be understood that this invention is not to be unduly limited to the illustrative embodiments set forth hereinabove.

We claim:

1. A method of making a thin film transistor comprising the steps of:
providing a substrate;
applying a gate electrode ink by inkjet printing;
applying a dielectric ink over by inkjet printing;
applying a semiconductor ink by inkjet printing; and
applying a source and drain electrode ink by inkjet printing.

2. The method according to claim 1 wherein the gate electrode ink is applied directly to the substrate.

3. The method according to claim 2 wherein the dielectric ink is applied over at least a portion of the gate electrode ink.

4. The method according to claim 3 wherein the semiconductor ink is applied over at least a portion of the dielectric ink and the source and drain electrode ink is applied over at least a portion of the semiconductor ink.

5. The method according to claim 3 wherein the source and drain electrode ink is applied over at least a portion of the dielectric ink and the semiconductor ink is applied over at least a portion of the source and drain electrode ink.

6. The method according to claim 1 wherein the semiconductor ink is applied directly to the substrate, the source and drain electrode ink is applied over at least a portion of the semiconductor ink, the dielectric ink is applied over at least a portion of the source and drain electrode ink, and the gate electrode ink is applied over at least a portion of the dielectric ink.

7. The method according to claim 1 wherein the source and drain electrode ink is applied directly to the substrate, the semiconductor ink is applied over at least a portion of the source and drain electrode ink, the dielectric ink is applied over at least a portion of the semiconductor ink, and the gate electrode ink is applied over at least a portion of the dielectric ink.

8. The method according to claim 1 wherein the semiconductor ink comprises a solvent and a semiconducting material comprising:
1-99.9% by weight of a polymer; and
0.1-99% by weight of a compound according to Formula I: 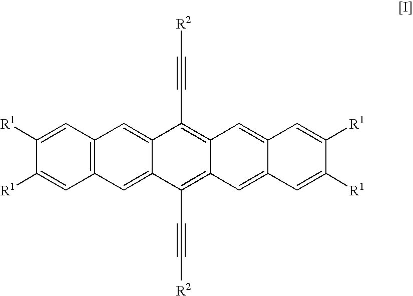
where each R¹ is independently selected from H and CH₃ and each R² is independently selected from branched or unbranched C2-C18 alkanes, branched or unbranched C1-C18 alkyl alcohols, branched or unbranched C2-C18 alkenes, C4-C8 aryls or heteroaryls, C5-C32 alkylaryl or alkyl-heteroaryl, a ferrocenyl, or SiR³₃ where each R³ is independently selected from hydrogen, branched or unbranched C1-C10 alkanes, branched or unbranched C1-C10 alkyl alcohols or branched or unbranched C2-C10 alkenes.

9. The method according to claim 8 wherein each R¹ is H and each R² is SiR³₃ where each R³ is independently selected from hydrogen, branched or unbranched C1-C10 alkanes, branched or unbranched C1-C10 alkyl alcohols or branched or unbranched C2-C10 alkenes.

10. The method according to claim 8 where each R¹ is H and each R² is SiR³₃ where each R³ is independently selected from branched or unbranched C1-C10 alkanes.

11. The method according to claim 8 where the compound according to formula I is 6,13-bis(triisopropylsilylethynyl)pentacene (TIPS-pentacene).

12. The method according to claim 8 where the polymer has a dielectric constant at 1 kHz of greater than 3.3.

13. The method according to claim 8 where the polymer is selected from the group consisting of: poly(4-cyanomethyl styrene) and poly(4-vinylphenol).

14. The method according to claim 8 where the polymer is poly(4-vinylphenol).

15. The method according to claim 8 where the polymer is a polymer comprising cyano groups.

16. The method according to claim 8 where the polymer is a substantially nonfluorinated organic polymer having repeat units of the formulas: 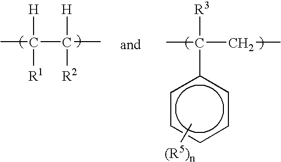
wherein:
each R¹ is independently H, Cl, Br, I, an aryl group, or an organic group that includes a crosslinkable group;
each R² is independently H, an aryl group, or R⁴;
each R³ is independently H or methyl;
each R⁵ is independently an alkyl group, a halogen, or R⁴;
each R⁴ is independently an organic group comprising at least one CN group and having a molecular weight of about 30 to about 200 per CN group; and
n=0-3;
with the proviso that at least one repeat unit in the polymer includes an R⁴.
